(19) United States
(12) Patent Application Publication
(10) Pub. No.: US 2005/0078934 A1
(43) Pub. Date: Apr. 14, 2005

(54) System for automated copying from a personal video recorder

(76) Inventors: Charles M. Fish, New Hope, PA (US); Charles A. Eldering, Doylestown, PA (US)

Correspondence Address: GOTTLIEB RACKMAN & REISMAN PC, 270 MADISON AVENUE, 8TH FLOOR, NEW YORK, NY, 100160601, US

(21) Appl. No.: 10/681,949

(22) Filed: Oct. 8, 2003

(51) Int. Cl. H04N 9/00; H04N 11/00

(52) U.S. Cl. 386/1

(57) ABSTRACT

A digitizing system is described that connects to a Personal Video Recorder for automatically making digital copies of programs stored within the Personal Video Recorder. These digital copies may be archived for future viewing, recorded on a media such as a CD, DVD, etc., shared on a computer network, sold or traded.

### BACKGROUND OF THE INVENTION

1. Field of Invention

This invention pertains to a system and apparatus for storing the output from a personal video recorder. The content is then stored and recorded on a CD, a DVD or similar media. The content can also be transmitted to others over a variety of networks including but not limited to broadcast, multicast, point-to-point, or peer-to-peer. Alternatively, the content may be stored on another device containing storage similar to that in the PVR (e.g. a hard drive).

2. Description of the Prior Art

Personal Video Recorders (also called PVRs or Digital Video Recorders), available from manufacturers such as TiVo, and SONICBlue, are devices similar to a Video Cassette Recorder (VCR) designed to record television programs. The PVR differs from a common VCR in that it digitizes, compresses and records all programs to an internal, non-removable hard disk drive or other digital storage device. PVRs are becoming more common in households as users discover the convenient features and flexibility of digital recording, as well as the advantages of having combined recording/program guide capabilities. With a PVR a user can, for example, find a program or series of programs of interest and direct the system to record an individual program, all of the programs in a series, or only the new episodes. PVRs also allow the user to “pause” live programming and resume playback several minutes to several hours later while the PVR continues to record the program. Some PVRs also allow the user to rate programs, and, based on the programs the user indicates are of interest, will “learn” what types of programs the user likes and will automatically record those types of programs. Other PVRs attempt to infer a profile of the viewer and automatically record programs that are a good match to the profile.

Since PVRs typically do not use removable storage media, and do not provide users with the ability to easily copy and distribute digital copies of content, they frequently have a feature called “Save to VCR”. With this feature the PVR will take a digitally recorded program and pass an analog copy of the program to a VCR so that the program can be recorded on a removable/archivable medium (typically, an analog video cassette tape). In some PVRs, the “Save to VCR” command causes the VCR to begin recording automatically, usually by using a so-called “IR Blaster” to start and stop the VCR through its infrared remote control input.

Storage of programs on analog tapes has a number of deficiencies. First, analog tapes do not provide the highest quality possible and degrade over time. Second, tapes are bulky and are therefore difficult to transport and require significant storage space.

For the foregoing reasons, there is a need for a system for automatically creating digital copies of content recorded on PVRs, and allowing that content to be stored outside of the PVR and freely distributed.

### SUMMARY OF THE INVENTION

A digitizing system is described that connects to a PVR in parallel with, or in place of a VCR. The digitizing system intercepts the analog audio and video signals generated by the PVR during a “Save to VCR” command. Upon receiving a “Start” command, the digitizing system automatically initiates digitization and compression of the video and audio signal outputs of the PVR and thus creates a digital copy of the material. In the event that additional information (e.g. title or other metadata) is presented to the VCR or to another device connected to the PVR, the digitizing system can also intercept that data and appropriately tag the newly created digital copy. The digitizing system provides a means for copying the digitized program to a removable storage medium or transferring the digitized program over a computer network.

The digitizing system can be a stand-alone dedicated device or may be implemented using a personal computer. The newly created digital copy of the content can be stored on a hard drive in the digitizing system, or the file can be streamed out for storage elsewhere in a computer network. Alternatively, the file can be shared or broadcast over a computer network, and individual users may choose to download and store the file on their local systems.

Alternatively, the PVR is modified so that when requested by a user, it outputs a program in a digital format. The program is then decoded (if needed), stored and viewed, recorded or distributed as desired.

These and other features and objects of the invention will be more fully understood from the following detailed description of the embodiments, which should be read in light of the accompanying drawings.

In this respect, before explaining the invention in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be used as a basis for designing other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The accompanying drawings, which are incorporated in and form a part of the specification, illustrate embodiments of the present invention and, together with the description serve to explain the principles of the invention.

FIG. 1 illustrates a prior art system for recording the output of a Personal Video Recorder using a Videocassette Recorder;

FIG. 2 illustrates a system for capturing and recording the output of a Personal Video Recorder;

FIG. 3 is a system level block diagram of a stand-alone digitizing system;

FIG. 4 is a system level block diagram of a personal computer based digitizing system;

FIG. 5 shows a typical Vertical Blanking Interval (VBI) signal;

FIG. 6 shows a system for storing the digital output of a Personal Video Recorder.

### DETAILED DESCRIPTION OF SPECIFIC EMBODIMENTS OF THE INVENTION

In describing an embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

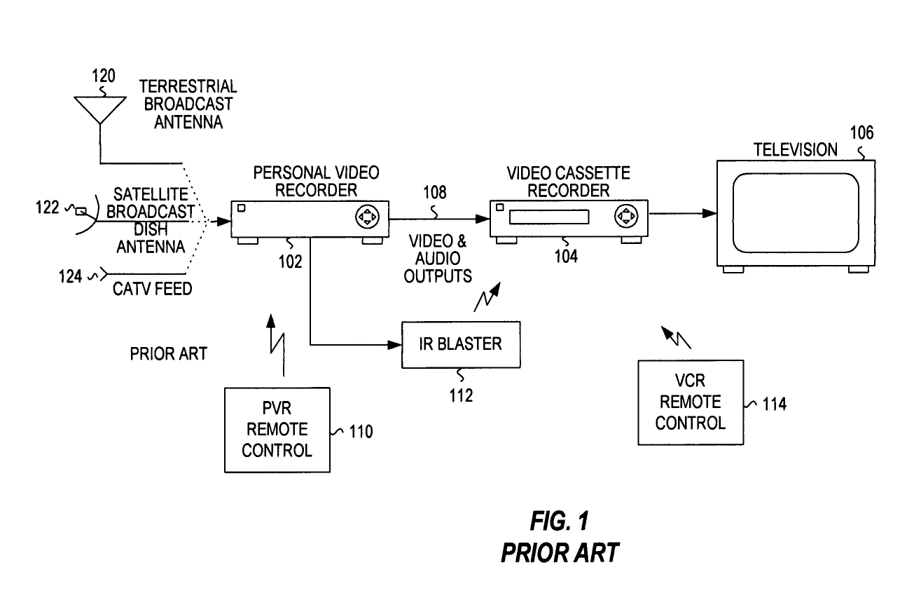

FIG. 1 illustrates a prior art system for recording the output of a Personal Video Recorder, available for example from TiVo Inc. of San Jose, Calif. In the prior art system, a Personal Video Recorder 102 is connected to one or more sources of programming. The sources of programming may include terrestrial broadcast, satellite broadcast, cable television (CATV), and the like. These sources of programming are received respectively by a Terrestrial Broadcast Antenna 120, a Satellite Broadcast Dish Antenna 122, and a CATV Feed 124. A source of programming comprises analog, digital or a combination of analog and digital programs. The Video and Audio Outputs 108 of the Personal Video Recorder 102 are connected to the inputs of Video Cassette Recorder 104. The outputs of Video Cassette Recorder 104 are connected to Television 106 for user viewing of programs from either Personal Video Recorder 102 or Video Cassette Recorder 104. To view programs from Personal Video Recorder 102, Video Cassette Recorder 104 is set to couple its input signals to its output.

Referring to FIG. 1, a user wishing to record a program previously stored on Personal Video Recorder 102 presses a specific key or key sequence on PVR Remote Control 110 to instruct the Personal Video Recorder 102 to initiate the “Save to VCR” function. Having received the “Save to VCR” command, Personal Video Recorder 102 first sends a “Record” command to Video Cassette Recorder 104 via IR Blaster 112. An IR Blaster is a device, well known in the art, used by one piece of equipment for sending infrared commands to a second piece of equipment (these codes are identical to those used by the infrared remote control of the second piece of equipment). Upon receiving a “Record” command, Video Cassette Recorder 104 begins to record the signals on Video and Audio Outputs 108 (assuming a recordable tape is loaded into Video Cassette Recorder 104). Personal Video Recorder 102 then begins to play the selected program. At the conclusion of the program, Personal Video Recorder 102 sends a “Stop” command to Video Cassette Recorder 104 via IR Blaster 112. The “Stop” command causes Video Cassette Recorder 104 to cease recording. At this point, the tape may be removed and saved for future viewing or left in Video Cassette Recorder 104 for further recording or viewing.

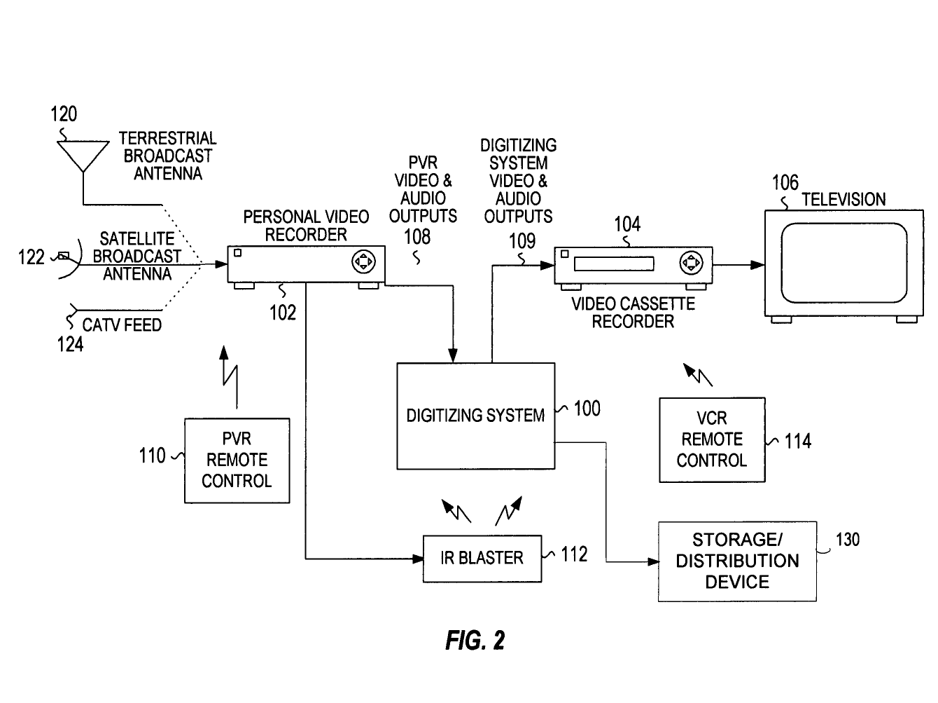

FIG. 2 illustrates one embodiment of a system for making digital copies of programs from a Personal Video Recorder similar to the one in FIG. 1. It includes a Digitizing System 100 that intercepts the analog audio and video signals from the Personal Video Recorder 102 to the Video Cassette Recorder 104. More specifically, the input from the Digitizing System 100 is connected to Video and Audio Outputs 108 of Personal Video Recorder 102. Digitizing System 100 provides analog Video and Audio Outputs 109 connected to Video Cassette Recorder 104. Output 109 is coupled to the Input 108 to allow the Digitizing System 100 to pass the analog signals from the Personal Video Recorder 102 to the Video Cassette Recorder 104 transparently. The outputs of Video Cassette Recorder 104 are connected to Television 106 for user viewing of programs from Personal Video Recorder 102, Video Cassette Recorder 104, and, optionally, Digitizing System 100. When a user initiates the “Save to VCR” function, the “Record” command is sent to IR Blaster 112 by Personal Video Recorder 102. The “Record” command is intercepted by Digitizing System 100, which begins to digitize, compress, and store the program (as discussed in more detail below) received from Personal Video Recorder 102 through Video and Audio Outputs 108. When Personal Video Recorder 102 issues a “Stop” command, Digitizing System 100 intercepts this command and terminates the digitization, compression, and storage processes.

The digitized program is then provided to a storage and distribution device 130, which stores the digitized program in memory. The device 130 may also be connected to other devices that selectively record the program on a CD or a DVD, or which distribute the program electronically to other locations. Device 130 can be incorporated into the Digitizing System 100, however, it is shown herein as a separate element for the sake of clarity.

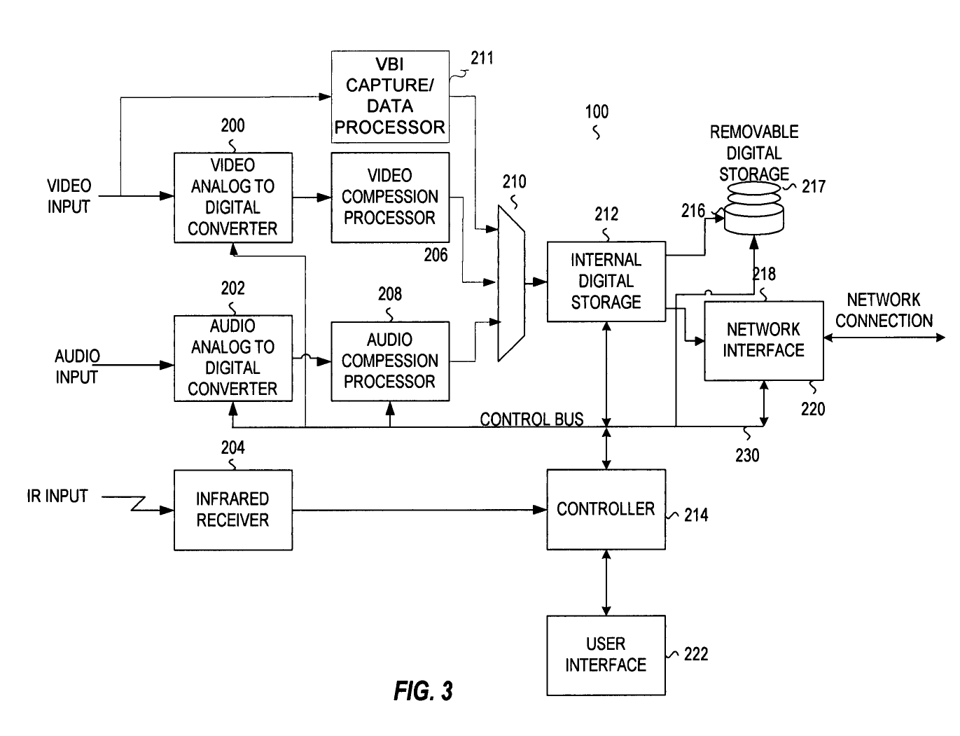

A block diagram of an embodiment of a stand-alone Digitizing System 100 and the associated and distribution device 130 is shown in FIG. 3. Infrared Receiver 204 receives commands from Personal Video Recorder 102 via IR Blaster 112. Upon receipt of a “Start” command, Controller 214 enables the processing and storage of the video and audio input through Control Bus 230. Video Analog to Digital Converter 200 and Audio Analog to Digital Converter 202 receive and convert analog video and audio inputs to digital form. Audio Analog to Digital Converter 202 may consist of one or more Analog to Digital Converter units, depending on the number of audio channels to be digitized. Digitized video is compressed by Video Compression Processor 206 using a video compression system such as MPEG-1, MPEG-2 or MPEG-4 or any other commercially available standards-based or proprietary video compression algorithm. Digitized audio is compressed by Audio Compression Processor 208 using a digital audio compression system such as MPEG-1 Level 1, MPEG-1 Level 2, MPEG-1 Level 3 (MP3) or any other commercially available standards-based or proprietary audio compression algorithm. The compressed video and audio are multiplexed by Multiplexer 210 and stored as a digital media file in Internal Digital Storage 212. In one embodiment, Internal Digital Storage 212 is a hard disk drive, but may be implemented using any digital read/write storage device, or a combination of such devices.

As shown in FIG. 3, the user interacts with Digitizing System 100 through User Interface 222 to direct Digitizing System 100 to copy digital media files from Internal Digital Storage 212 to Removable Digital Storage 216. User Interface 222, in one embodiment, is a keyboard or keypad that is part of or attached to Digitizing System 100. Once copied, Removable Digital Storage Media 217 may be removed from Digitizing System 100 for use in another device, such as a DVD player or Personal Computer. The user can also direct Digitizing System 100 through User Interface 222 to copy digital media files from Internal Digital Storage 212 to Network Interface 218. The digital media files then travel through Network Connection 220 to a computer or other device connected to the computer network. User Interface 222 communicates user commands to Controller 214, which uses Control Bus 230 to facilitate the copying of digital media files from Internal Digital Storage 212 to Removable Digital Storage 216 or Network Interface 218. The user may also direct copying operations of the Digitizing System 100 through Infrared Receiver 204 or through Network Connection 220. In one embodiment, Digitizing System 100 is configured as a Web server or network server based on, for example, one or more of the following networking protocols: Hypertext Transfer Protocol (HTTP), File Transfer Protocol (FTP), Server Message Block (SMB), Internetwork Packet Exchange (IPX) and Network File System (NFS). Those skilled in the art will recognize that other protocols may be used in place or, or in addition to, those mentioned here.

Standard video signals include a so-called “Vertical Blanking Interval”. The Vertical Blanking Interval (VBI) makes up the portion of the video signal during which the electron beam in the display tube (Cathode Ray Tube) within the television receiver returns to its origin after finishing a complete scan. Information present in the video signal during the VBI is not typically seen by the television viewer. For video signals based on the NTSC standard, the VBI consists of approximately 42 horizontal lines per video frame (a video frame in the NTSC standard comprises a total of 525 horizontal lines). Some of these 42 horizontal lines within the VBI are used by many television broadcasters to carry test signals for the purpose of measuring or improving the reception of television broadcasts (for example, U.S. Pat. No. 5,121,211, entitled “System for echo cancellation comprising an improved ghost cancellation reference signal”, describes a system to reduce multipath effects—ghosts—by incorporating a reference signal in the VBI that is used by the receiver to cancel multipath propagation). Other horizontal lines within the VBI are used by many television broadcasters to carry digital data signals that provide general information or descriptive information (metadata) associated with the broadcast program content. The most common of this digital data is the so-called “Closed-Captions”, which provide on-screen captions for viewers with hearing impairments. Additional metadata includes rating and content descriptors for use with “V-Chip” enabled television receivers, time-of-day information, and teletext. These data services are described, for United States television systems, in the Electronic Industries Association standard: “EIA 608: Recommended Practice for Line 21 Data Service”.

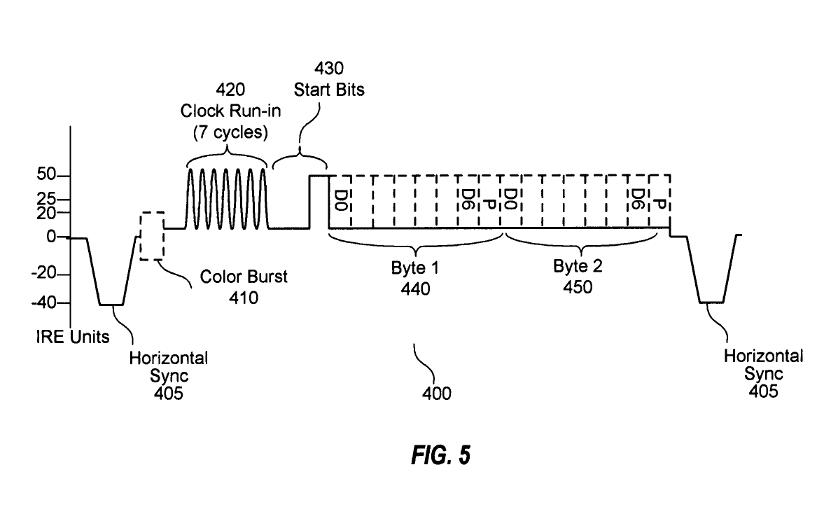

FIG. 5 illustrates how data is encoded in video line 21 as described in EIA 608. Line 21 of video signal 400 includes horizontal sync pulse 405, color burst 410, clock run-in 420, start bits 430, and 2 bytes (16 bits) of data 440 and 450. Clock run-in 420 establishes the amplitude and timing of the data bits. Following clock run-in 420 are three start bits 430 (“0”, “0”, “1”) and data bytes 440 and 450.

The video compression process used by Digitizing System 100, is preferably optimized for processing video information and may not preserve the digital data on the horizontal lines within the VBI with sufficient quality to enable television receivers to accurately read this information from the decompressed and reconstructed video signal. To ensure that this data is faithfully reproduced after compression and subsequent decompression, Digitizing System 100 may, in one embodiment, include a VBI capture/data processor 211 that decodes the digital data on the horizontal lines within the VBI and store it in digital form along with the stored file of compressed video and audio data representing the recorded program. During subsequent decompression and playback of the stored file, the digital data would be re-encoded and inserted onto the appropriate horizontal lines within the VBI of the reconstructed video signal. In another embodiment, Digitizing System 100 does not store the information from the VBI of the recorded program. In this embodiment, subsequent decompression and playback of the stored file will not include the data stored within the VBI of the original program.

In addition to the data derived from the horizontal lines within the VBI, Digitizing System 100 may also add metadata to the stored file to identify the name, time, date and other associated information. For example, the Digitizing System 100 may (automatically or under user control) add information such as which user caused the file to be stored, how long the file shold be stored for, a priority storage code (i.e., do not overwrite unless a higher priority storage file is to be stored), automatic or user-selected codes relating to the content of file (e.g., “2 thumbs up” or “chick-flick”) or the like. This additional metadata may be derived from a time/date clock within Digitizing System 100 (not shown), signals relayed from Personal Video Recorder 102 through IR Blaster 112, or information entered manually by the user.

Once the digital media file has been stored in its entirety, the user has the option to record this file on a removable magnetic or optical media, or send it over a computer network to a computer or other device. Examples of removable magnetic media include floppy disks, hard disks, and Zip® disks. Optical media are those that incorporate a substrate whose optical properties can be modified either permanently (so-called “write-once” media) and those that can be repeatedly written, erased, and rewritten. Examples of removable optical media include CR-R, CD-RW, DVD-R, DVD+R, DVD-RW, DVD+RW, DVD-RAM.

In an alternate embodiment, the user may configure the system to transfer the stored program to a hard drive, memory stick, or other electro-magnetic or electrical storage media, and record and/or transmit the program at a latter time.

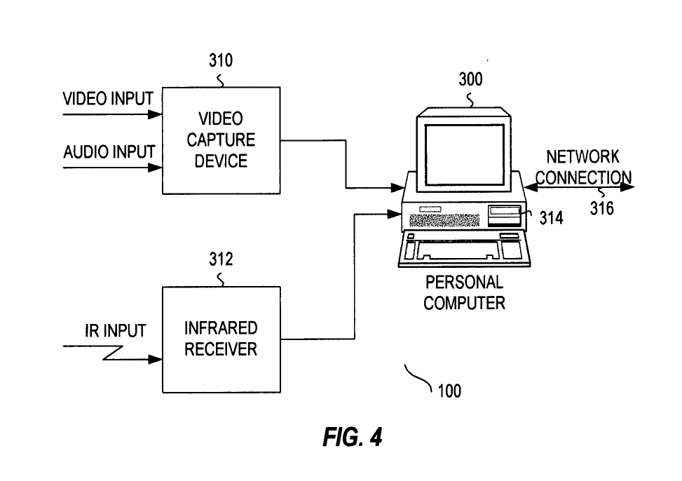

FIG. 4 shows another embodiment for Digitizing System 100. In this embodiment, Personal Computer 300 is equipped with Video Capture Device 310 and IR Receiver 312. Personal Computer 300 is provided with a software program and device drivers necessary to implement the functionality of Digitizing System 100 described herein. In one embodiment, Video Capture Device 310 is an external component that connects to Personal Computer 300 through a Universal Serial Bus (USB), Parallel, or IEEE-1394 (FireWire) link. In an alternate embodiment, Video Capture Device 310 is internal to Personal Computer 300 and connects to Personal Computer 300 through a Peripheral Component Interconnect (PCI) local bus or an Advanced Graphics Port (AGP) interface (not shown). Device 310 may be, for example, a video card available, for example, from ATI Technology Inc. of Santa Clara, Calif. The Video Capture Device receives the analog Video and Audio signals from the Personal Video recorder and converts them into digital signals using one of the compression schemes mentioned above. In addition, the Video Capture Device may have some digital circuitry that accelerates the compression algorithm.

Infrared Receiver 312 receives commands from Personal Video Recorder 102 via IR Blaster 112 and coveys them to Personal Computer 300. In one embodiment, Video Capture Device 310 and Infrared Receiver 312 are incorporated into the same electronics assembly or printed circuit board and communicate with Personal Computer 300 through the same means. In an alternate embodiment, Infrared Receiver 312 is a stand-alone unit that communicates with Personal Computer 300 through a Universal Serial Bus (USB), RS-232 serial interface, or parallel interface. Upon receipt of a “Start” command from Personal Video Recorder 102, Personal Computer 300 directs Video Capture Device 310 to begin digitizing and compressing the video and audio inputs. Personal Computer 300 receives the digitized compressed video and audio signals from Video Capture Device 310 and stores them on its internal hard disk drive or other internal digital storage device.

Referring to FIG. 4, the user may interact with Personal Computer 300 to direct it to copy digital media files from its internal hard disk drive or other internal digital storage to Removable Storage Drive 314. In one embodiment, Removable Storage Drive 314 is a recordable DVD drive. Once copied, the media may be removed from Removable Storage Drive 314 for future use, used in another device (such as a DVD player), or sold or traded with other interested parties. Alternatively, the user may direct Personal Computer 300 to copy digital media files from its internal hard disk drive or other internal digital storage to Network Connection 316. The digital media files then travel through Network Connection 316 to another computer or other device connected to the computer network. In a preferred embodiment, Personal Computer 300 runs a software program that allows users anywhere on the Internet to access and download digital media files from the internal hard disk drive or other internal digital storage of Personal Computer 300. Examples of this type of software-called Peer-to-Peer or P2P file sharing software—include Napster, Kazaa, Morpheus, and Gnutella. In an alternate embodiment, Personal Computer 300 is configured as a Web server or network server based on, for example, one or more of the following networking protocols: Hypertext Transfer Protocol (HTTP), File Transfer Protocol (FTP), Server Message Block (SMB), Internetwork Packet Exchange (IPX) and Network File System (NFS). Those skilled in the art will recognize that other protocols may be used in place of, or in addition to, those mentioned here.

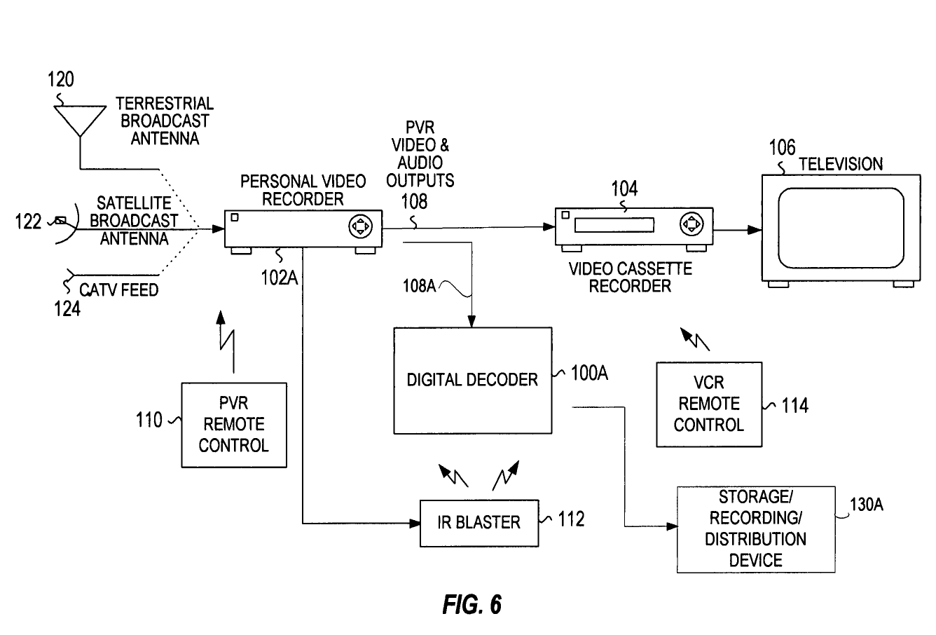

Some of the Personal Video Recorders presently available on the market are very flexible and permit a user to modify its operation. FIG. 6 shows a system with a PVR 102A, a VCR 104, a television set 106, a digital decoder 100A and a storage/recording/distribution device 130A. The PVR 102A is operated by a PVR remote control device 110 and the VCR is operated by a VCR remote control 114. As previously described, when the PVR 102A receives a certain control signal from its remote control 110, it sends a program in the form of analog video and audio signals to the VCR 104 and takes over its operation through the IR blaster 112. However, in this system, the personal video recorder 102A has been modified so that when it receives a certain predetermined command from its PVR remote control 110, it also transmits a preselected program as digital data on its digital output 108A. For example, this output may appear on a USB port, or other similar high speed data port. The output is fed to the digital decoder 100A. This decoder 100A can be provided with an infrared receiver similar to the receiver 204 in FIG. 3 which intercepts a signal from either the PVR remote control 110 or the IR blaster 112 and alerts the decoding circuitry to receive and start processing the digital data and decode it. This processing may be necessary in case the PVR 102A may be storing the program using some encoding scheme.

Once the data has been decoded, it can be stored in a local memory. The data can also be recorded on a portable media and/or distributed by device 130A, in the same manner as discussed above for the embodiment of FIGS. 2 and 3. The digital decoder 100A and the storage/recording/distribution device can be implemented as a single stand-alone dedicated device or by a PC, however, they are shown here as separate elements for the sake of clarity.

The digital data from the decoder 100A can also be sent to the television set 106 so that it can be viewed directly.

The many features and advantages of the invention are apparent from the detailed specification. Thus, the appended claims are intended to cover all such features and advantages of the invention that fall within the true spirit and scope of the invention. Further, since numerous modifications and variations will readily occur to those skilled in the art, it is not desired to limit the invention to the exact construction and operation illustrated and described. Accordingly, all appropriate modifications and equivalents may be included within the scope of the invention.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

1. A method for automated copying from a personal video recorder, the method comprising the steps of:
receiving a first signal indicative of a playback;
receiving a second signal from the personal video recorder, wherein the second signal is an analog signal containing the playback;
digitizing the second signal in response to the first signal to create a digital representation of the playback; and
storing the digital representation of the playback.

2. The method of claim 1, further comprising the step of:
transmitting the digital representation of the playback over a network.

3. The method of claim 2, further comprising the step of:
sharing the digital representation of the playback in a peer-to-peer network configuration.

4. The method of claim 1, further comprising the step of:
copying the digital representation of the playback onto a digital storage medium.

5. The method of claim 4 wherein the copying is performed on a transportable digital storage medium.

6. The method of claim 1 further comprising compressing the digital representation of the playback and storing the compressed digital representation.

7. The method of claim 1 wherein said first signal is generated by said personal video recorder.

8. An apparatus for creating a digitized copy of a recorded program on a personal video recorder, the apparatus comprising:
a first subsystem for receiving a first signal, the first signal indicating the commencement of playback of a recorded program from the personal video recorder;
a second subsystem for intercepting a second signal, the second signal containing an analog representation of the recorded program; and
a third subsystem for creating a digitized version of the intercepted signal.

9. The apparatus of claim 8, further comprising:
a storage medium for storing the digitized signal.

10. The apparatus of claim 8, further comprising:
a transmitting circuit for transmitting the compressed version of the digitized signal.

11. The apparatus of claim 8 further comprising a fourth subsystem for compressing the digitized signal.

12. A system for automatically creating a digitized copy of a recorded program from a personal video recorder, the apparatus comprising:
an analog-to-digital converter for digitizing the analog video component of the recorded program to create a digitized video signal;
an analog-to-digital converter for digitizing analog audio components of the recorded program to create at least one digitized audio signal;
a receiver for receiving a control signal, the control signal indicating the commencement or conclusion of playback of the recorded program from the personal video recorder; and
a digital storage device for storing the digitized video signal and the digitized audio signal.

13. The system of claim 12 further comprising a first compression unit that compresses the digitized video signal to produced a compressed digitized video signal, and a second compression unit for compressing the digitized audio signal to produce compressed digitized audio signal.

14. The system of claim 13, wherein the first compression unit is an electronic circuit capable of compressing the digitized video signal.

15. The system of claim 14, wherein the first compression unit is computer based software utilizing at least one video compression algorithm.

16. The system of claim 15, wherein the computer based software is augmented by an electronic circuit that accelerates the at least one video compression algorithm.

17. The system of claim 12, further comprising:
a transmitter for transmitting the digitized video signal and the digitized audio signal.

18. The computer system of claim 12, further comprising:
a network interface subsystem for sharing the digitized video signal and the digitized audio signal with other computer systems on a computer network.

19. The system of claim 18 wherein the network interface subsystem is a client-server computer network.

20. The system of claim 18 wherein the network interface subsystem is a peer-to-peer network configuration.

21. The system of claim 12 further comprising:
a storage system with removable medium for storing the digitized video signal and the digitized audio signal on a write-once removable medium.

22. The system of claim 12 further comprising:
a storage system adapted for use with a removable medium for storing the digitized video signal and the digitized audio signal on a rewritable removable medium.

23. A method for automated copying of content from a personal video recorder, the method comprising the steps of:
receiving a first signal from the personal video recorder wherein the first signal is indicative of the initiation of a playback of the content;
intercepting a second signal from the personal video recorder, wherein the second signal is an analog signal containing the playback and wherein the analog signal contains a video component that contains additional information related to the playback;
digitizing the video component signal to create a digitized version of the playback;
digitizing the information; and
storing the video component and the digitized information.

24. The method of claim 23, further comprising the step of:
transmitting the digitized video component and the digitized information over a network.

25. The method of claim 23, further comprising the step of:
sharing the digitized video component and the digitized information in a peer-to-peer network configuration.

26. The method of claim 23, further comprising the step of:
copying the digitized video component and the digitized information onto a transportable digital storage medium.

27. The method of claim 26 wherein said digital storage media is an optical media.

28. A method for automated copying of a playback from a personal video recorder, the method comprising the steps of:
receiving a first signal indicative of the initiation of a playback;
intercepting a second signal from the personal video recorder, wherein the second signal is an analog signal containing the playback and wherein the analog signal contains an audio component and a video component;
digitizing the video component of the playback to create a digitized video component;
digitizing the audio component of the playback to create a digitized audio component; and
storing the digitized video and audio components.

29. The method of claim 28 wherein said first signal is generated by the personal video recorder.

30. The method of claim 28 wherein said playback recording includes an imbedded data subcomponent formed of data related to the playback.

31. The method of claim 30 wherein said data subcomponent is imbedded in said video component.

32. The method of claim 31 wherein said data component is encoded within a vertical blanking interval of said video component.

33. The method of claim 30 further comprising digitizing said data subcomponent to define digitized data.

34. The method of claim 33 further comprising storing said digitized data with together with said digitized video and audio components.

35. The method of claim 28 wherein said data component is disposed within a blanking interval of the video component.

36. The method of claim 28, further comprising the step of:
transmitting the digitized video and audio components over a network.

37. The method of claim 28, further comprising the step of:
sharing the video and audio subcomponents in a peer-to-peer network configuration.

38. The method of claim 28, further comprising the step of:
copying the video and audio subcomponents onto a transportable digital storage medium.

39. The method of claim 38 wherein the transportable digital storage medium is an optical disc.

40. A method for automated copying from a personal video recorder, the method comprising the steps of:
receiving a signal from the personal video recorder containing a recorded program in response to an automated copy command; and
storing the signal on a digital media.

41. The method of claim 32 wherein said signal is an analog signal, further comprising digitizing said signal, compressing the digitized signal and storing the compressed signal.

42. The method of claim 32 wherein said signal is an encoded digital signal, further comprising decoding said digital signal and storing the decoded signal.
